(19) United States
(12) Patent Application Publication
(10) Pub. No.: US 2011/0296119 A1
(43) Pub. Date: Dec. 1, 2011

(54) Stored Data Reading Apparatus, Method and Computer Apparatus

(75) Inventor: Qian Zhao, Beijing (CN)

(73) Assignee: LENOVO (BEIJING) CO. LTD., Beijing (CN)

(21) Appl. No.: 13/147,800

(22) PCT Filed: Feb. 9, 2010
(86) PCT No.: PCT/CN2010/070588

§ 371 Date: Aug. 3, 2011

(30) Foreign Application Priority Data
Feb. 9, 2009 (CN) 200910077407.3

(51) Int. Cl. G06F 12/00

(52) U.S. Cl. 711/154; 711/E12.001

(57) ABSTRACT

The present invention proposes a stored data reading device, comprising a first storage module for storing first data, the first storage module has a first reading speed, a second storage module for storing second data, the second data being the same with at least a part of the first data, the second storage module having a second reading speed, and the second reading speed being greater than the first reading speed, a request acquiring module for acquiring a reading request for third data, the third data being the same with at least a part of the first data. With the stored data reading device of the invention, the data access speed can be accelerated while the production cost can be significantly lowered.

### TECHNICAL FIELD

The present invention relates generally to data reading and writing field, and more particularly to a stored data reading device and method capable of improving reading speed and a computer device including the stored data reading device.

### BACKGROUND

Access to a rotary magnetic disk typically requires a seeking time of about 4 ms to 10 ms, such as reading a small file at random, and thus over 95% of the time is spent on seeking. However, a storage device, such as flash medium, does not have any mechanical device such that seeking time is almost nonexistent. The speed of which a file is read from a storage device of flash medium is much faster than that of which such file is read from a rotary magnetic disk.

For a USB ((Universal Serial Bus) disk having a storage medium with a relatively low price, where a writing life cycle of the USB disk is 10,000 times of writing, it is sufficient for applications stored in the USB disk in which the cost is quite low.

Statistic data shows that 90% of the operating system load (OS load) is for reading operations, and 10% of the OS load is for writing operations, and 80% of the load of a major program is reading operations, and 20% of the load is writing operations. A buffering for the reading operations is more important in increasing the performance for reading stored data.

As described above, it is desirable to have a device and method capable of increasing the entire disk reading speed while lowering the cost.

### SUMMARY

In view of the above issues, the present invention provides a stored data reading device/method (also referred to as a stored data reading device or a method) and a computer device capable of promoting stored data read performance while further lowering the cost.

In one aspect of the invention, a stored data reading device comprises a first storage module for storing first data, wherein the first storage module has a first reading speed; a second storage module for storing second data, the second data being the same with at least a part of the first data, the second storage module having a second reading speed, and the second reading speed being greater than the first reading speed; a request acquiring module for acquiring a reading request for third data, the third data being the same with at least a part of the first data; and a reading module for reading the third data from the second storage module when the second storage module includes the third data; and reading the third data from the first storage module when the second storage module does not include the third data therein.

The device may further include a determining module configured for determining whether the second storage module includes the third data based on a file list, and outputting the determination result to the reading module wherein the file list stores information for describing the second data.

The device may further include a filtering module configured for processing a first target address to obtain a second target address, the second target address pointing to the second storage module, wherein the first target address is included in the reading request for the third data, the first target address pointing to the first storage module.

Preferably, the reading module performs a reading operation to the second storage module based on the reading request including the second target address in order to determine whether the second storage module includes the third data.

Preferably, the reading module performs a reading to the file list based on the reading request including the second target address to determine whether the second storage module includes the third data and outputting the determination result to the reading module.

The second storage module may store the second data in a form of file.

The second data may be the data on which the reading requirement is greater than the modification requirement.

According to another aspect of the invention, a stored data reading method comprises acquiring a reading request for third data, the third data being the same with at least a part of first data, the first data being stored in a first storage module, the first storage module having a first reading speed; and reading the third data from a second storage module when the second storage includes the third data, wherein the second storage module is used to store second data, the second data being the same with at least a part of the first data, the second storage module including a second reading speed, the second reading speed being greater than the first reading speed.

The stored data reading method may further comprise after the acquiring the reading request for the third data, determining whether the second storage module includes the third data based on a file list, and outputting the determination result wherein the file list stores information for describing the second data.

The stored data reading method may further comprise after the acquiring the reading request for the third data, processing a first target address to obtain a second target address, the second target address pointing to the second storage module, wherein the first target address is included in the reading request for the third data, the first target address pointing to the first storage module.

The stored data reading method may further comprise performing a reading operation to the second storage module based on the reading request including the second target address to determine whether the second storage module includes the third data therein.

The stored data reading method may further comprise performing a reading to the file list based on the reading request including the second target address in order to determine whether the second storage module includes the third data and outputting the determination result.

According to another aspect of the invention, a computer device comprises a stored data reading device that includes a first storage module for storing first data, wherein the first storage module havng a first reading speed; a second storage module for storing second data, the second data being the same with at least a part of the first data, wherein the second storage module having a second reading speed, and the second reading speed being greater than the first reading speed; a request acquiring module for acquiring a reading request for third data, the third data being the same with at least a part of the first data; and a reading module for reading the third data from the second storage module when the second storage module has the third data; and reading the third data from the first storage module when the second storage module does not have the third data.

By using the stored data reading device of the present invention, since the second storage module with a relatively low price is used to perform read-only operations, the performance of the stored data reading device can be elevated, the access speed can be accelerated, while the production cost may be significantly reduced.

### BRIEF DESCRIPTION OF THE DRAWINGS

Drawings described herein are used to provide a better understanding about the invention, which constitute a part of the present application, and the illustrative embodiments of the invention and their descriptions are used to explain the invention, but not used as an improper limitation on the invention. In the drawings:

FIG. 1 is a schematic block diagram showing an existing file access system;

FIG. 2 is a schematic block diagram showing a file access system according to an embodiment of the invention;

FIG. 3 is a flowchart showing an embodiment of the invention in FIG. 2;

FIG. 4 is a schematic block diagam showing a file access system according to another embodiment of the invention;

FIG. 5 is a flowchart showing another embodiment of the invention in FIG. 4; and

FIG. 6 is a schematic block diagram showing the connection performed between storage cards and a system according to an embodiment of the invention.

### DETAILED DESCRIPTION

With reference to the drawings, the particular embodiments of the invention is explained.

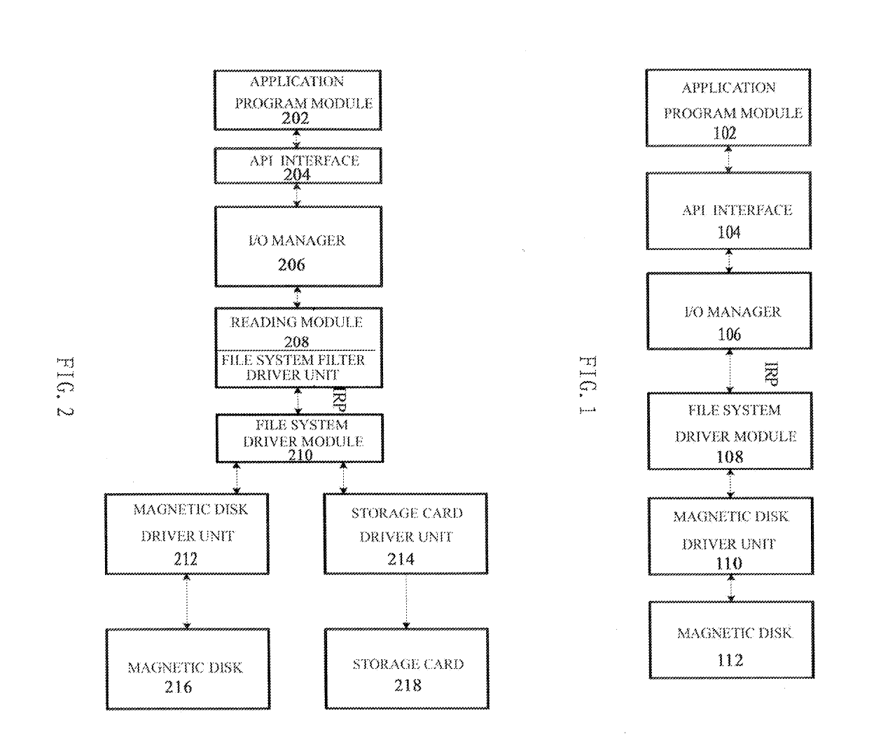

FIG. 1 is a schematic block diagram showing an existing file access system. An I/O manager 106 transmits a file access request IRP (an I/O request packet), which is sent from an application program module 102 through an API interface 104, to a file system driver module 108, and performs corresponding reading and writing operations on a magnetic disk 112 by a magnetic disk driver module 110.

Because the access to a rotary magnetic disk requires a seeking time of about 4 ms to 10 ms, in the case of reading a small file at random, about 95% and above of time is spent on seeking. A storage card, such as a flash storage medium, which has no mechanical element, would nearly not need any seeking time. The speed of which a file is read from a storage device of flash medium is much faster than the speed of which such file is read from a rotary magnetic disk. Placing all files with read-only attribute on a storage card and reading them first from the storage card when reading those files can accelerate the hard disk read performance. Since a storage card with a relatively low price has a disadvantage of a relatively short writing life cycle, the present invention employs the reading feature to avoid such concern.

For example, in a system there are many files which are not modified frequently, i.e., the reading requirement to those files is greater than the modification requirement on those files. The files to which the reading requirement is greater than the modification requirement may include, for example, Dynamic Link Library/Executable Program (dll/exe) files and so on, which normally do not have modification or writing issues. The files which are often accessed by the system can be copied to the flash storage medium, such as Security Digital card (SD card). When the system is reading a file, the system first searches the SD card, and if it cannot locate the file on the SD card, then the system searches the rotary magnetic disk, such as hard disk drive. As a result, the purpose of accelerating the reading operation can be achieved. Because laptop computers are frequently configured with card readers, the existing card readers can be used to accept SD cards which are plugged in the card readers in order to function as caches. The present invention is caching based on the file access while the prior art is caching based on the sector access.

A stored data reading device according to an embodiment of the invention is described in detail with reference to FIG. 2. In the embodiment, the stored data reading device increases the stored data reading speed by a storage card, performs interception operations to the reading and writing operations on the magnetic disk which is executed by the operating system by using a file filtering driver, and first checks whether the file to be accessed has a copy on a SD card. In such instance, the system reads corresponding data directly from the SD card, and if not, the system proceeds to deliver the operation to the magnetic disk. The file on the SD card represents the copy of the file on the HDD, so even in the case that the storage card is removed or damaged, this does not affect the system. FIG. 2 is a schematic block diagram showine a file access system according to an embodiment of the invention. As shown in FIG. 2, compared to the traditional file access system as shown in FIG. 1, according to the embodiment of the invention, a reading module 208 is added, which includes a file system filter driver unit.

According to the present embodiment, the file system filter driver unit can implement the effect of promoting the magnetic disk performance in two modes, which is described in detail with respect to FIGS. 2-4.

FIG. 2 illustrates a schematic block diagram of a file access system (mode 1) according to an embodiment of the invention. A request acquiring module (not shown) is configured to monitor a file access request IRP from an application program module 202 through an API interface module 204 and an I/O manager 206. The file system filter driver unit modifies the path of the file access in the IRP to a storage card 218, and transmits it to an file system driver module 210 in the lower layer. The file system driver module 210, after receiving the modified IRP, performs a reading on the storage card 218 through a storage card driver unit 214. If the reading is successful, which means that the storage card 218 has such file, while if the reading is not successful, an error information is returned. The file system filter driver unit determines whether the reading is successful. And if so, it returns the returned IRP information to the upper layer; if not, it restores the path of the IRP, retransmits it to the file system driver module 210 in the lower layer, and reads the file from a hard disk 216 through a magnetic disk driver unit 212.

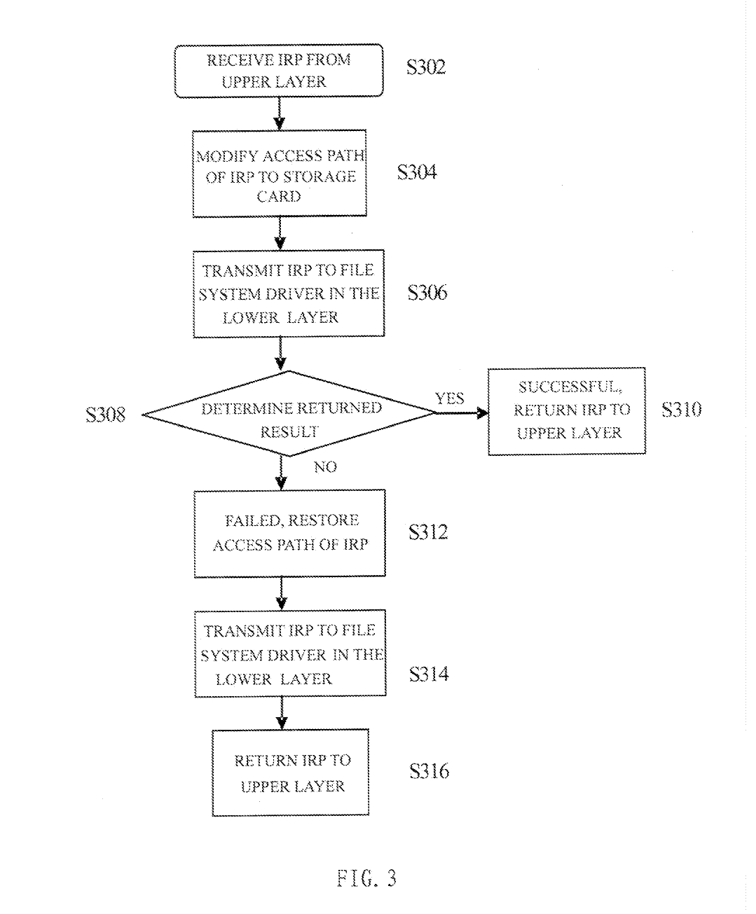

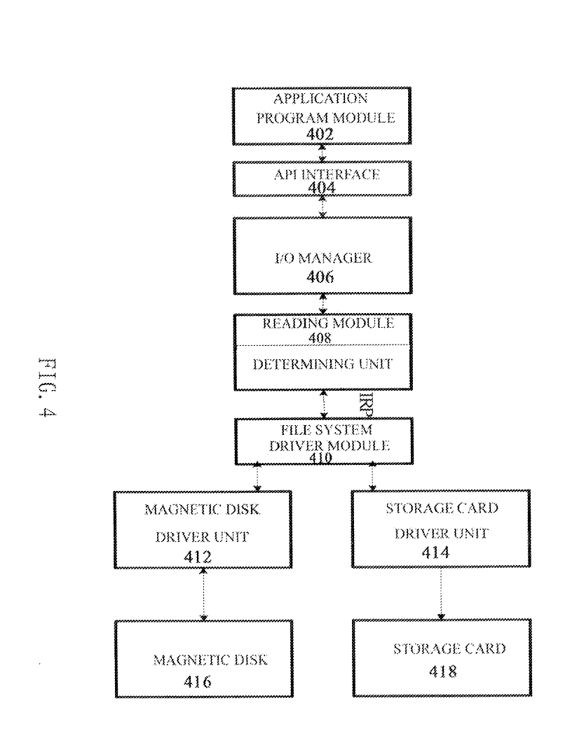

FIG. 3 is a flow chart illustrating a file access system (mode 1) according to an embodiment of the invention. As shown in FIG. 3, after a request acquiring module receives an IRP from the upper layer (step S302), a file system filter driver unit modifies the access path in the IRP to make it point to a storage card (step 304), and transmits the modified IRP to a file system driver in the lower layer (step S306). The file system driver in the lower layer receives the IRP, performs a reading operation to the storage card through a storage card driver, and returns a result indicating whether the storage card stores the corresponding data therein. The file system filter driver unit determines whether the returned result indicates the reading is successful, If so, it returns the IRP to the upper layer (step S310); if not, it restores the access path of the IRP (step S312), transmits the IRP to the file system driver in the lower layer (step S314), and performs a reading operation on a magnetic disk through a magnetic disk driver (step S316).

The mode 2 adopted by the file system filter driver unit is that the file system filter driver unit performs a read operation to a file list, where the file list stores related information (such as filename, file identification and so on) for describing the data stored in the storage card, and the file list can be stored on a storage card, an HDD, or any position which can be read by the reading module 208. Thus, when the request acquiring module (not shown) acquires a file access request IRP that is sent from the application program module 202 through the API interface module 204 and the I/O manager 206 in FIG. 2, the file system filter driver unit performs a modification on the access path of the IRP to make it point to the storage card. At the same time, it fetches the filename of the file to be accessed from the IRP, then search the file list. If the file list has corresponding data, it transmits the modified IRP to the file system driver in the lower layer, and when the file system driver in the lower layer receives this IRP, it will perform a reading operation to the storage card through the storage card driver to read the corresponding file data. Otherwise, it restores the access path of the IRP, transmit the IRP to the file system driver in the lower layer, use the magnetic disk driver to perform a reading operation to the magnetic disk, and return the IRP to the upper layer.

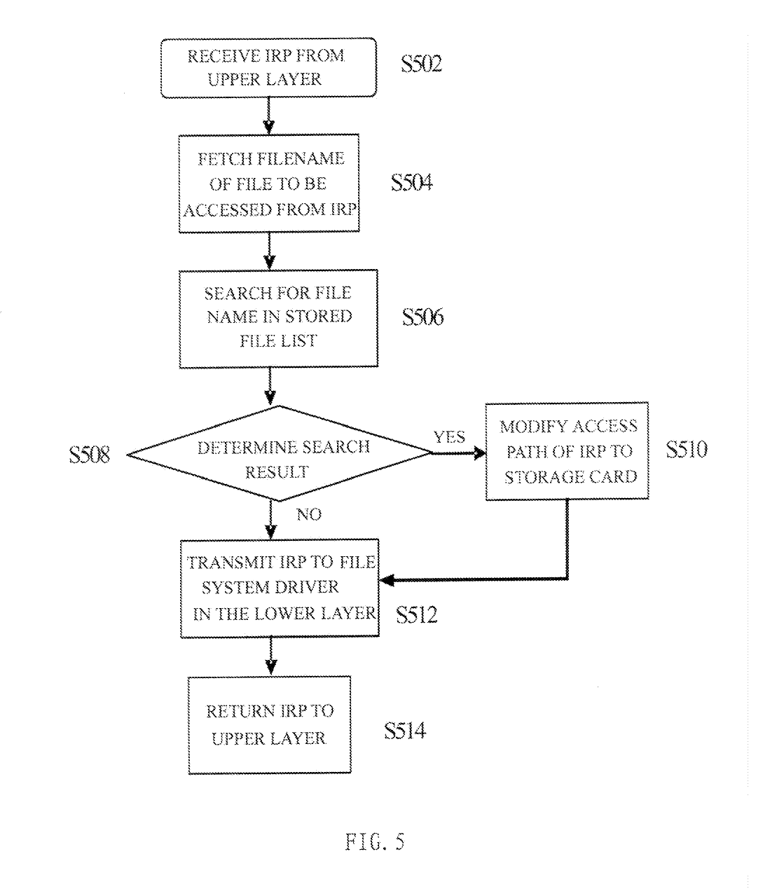

FIG. 4 is a schematic block diagram showing a file access system according to another embodiment of the invention. FIG. 4 differs from FIG. 2 in that the reading module includes a determining unit instead of the file system filter unit. Its detailed workflow is explained with reference to FIG. 5. FIG. 5 is a flow chart showing the file access system according to another embodiment of the invention in FIG. 4. As shown in FIG. 5, after a request acquiring module (not shown) receives an IRP from the upper layer (step S502), a reading module 408 in FIG. 4 monitors a file access request IRP that is sent from an application program module 402 through an API interface module 404 and an I/O manager 406, it fetches the filename of the file to be accessed from the IRP (step S504), then it searches the file list (the file list stores information for describing the data stored in a storage card, such as filename, identifier and so on) by the determining unit. If the corresponding information is found, the determining unit outputs the determination result indicating that a storage card 418 has this file (yes, in step S508), modifies the path of the file access in the IRP to the storage card 418 (step S510), and then transmits the modified IRP to an file system driver module 410 in the lower layer (step S512). After the file system driver module 410 receives the modified IRP, it performs a reading to the storage card 418 through a storage card driver unit 414. If there is no such file found (no, in step S508), it does not modify the path, and transmits the IRP directly to the file system driver module 410 in the lower layer (step S512), uses a magnetic disk driver unit 412 to read the file from a hard disk 416, and returns the IRP to the upper layer (step S514).

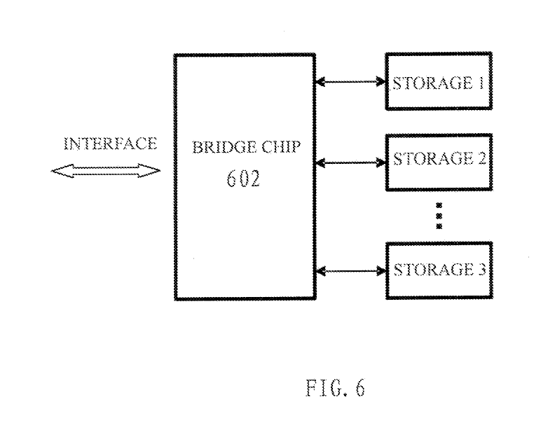

Currently, the data reading and writing speed of a rotary magnetic disk is about 100 MB/s. The interface speed of the new USB 3.0 standard can reach up to 300 MB/s. The new SD standard (SDXC) increases the interface speed of SD cards up to 300 MB/s. Thus, the data reading and writing speed of a storage card has been much greater than the data read and write speed of a rotary magnetic disk. Although now the interface speed of a storage card (SD) is about 25 MB/s, the interface speed can he increased by connecting a plurality of SD cards in parallel (for example, by connecting 6 SD cards in parallel, the interface speed can reach 120 MB/s) through a bridge chip (as shown in FIG. 6) to compose RAID working mode, and the data transmission is performed by connecting, for example, SATA interface with the system.

FIG 6 is a schematic block diagram showing the data transmission link between storage cards and a system according to an embodiment of the invention. As shown in FIG. 6, the number of the storage cards can be one or more. In the case of N cards (N≧2), the bandwidth for data reading is N times of that in the case of 1 card. A bridge chip 602 is responsible for coordinating the plurality of cards to work at the same time, for example, to compose RAID working mode.

The present invention is not limited to the embodiments as described above in using an SD card as the storage card, but may extend to further use other storage mediums such as SSD, SDHC, CF card, microSD, TF, MMC, XD, miniSD, memory stick, SDXC, xFast, etc. The data transmission link in the invention is also not limited to the transmission link based on USB interface, but can also include the data transmission link, for example, based on SATA interface, PCIe interface, and ExpressCard interface.

In summary, the invention provides a stored data reading device. In the device a storage card is used as a reading cache thereby promoting the reading speed and effectively lowering the production cost.

In addition, the file access systems described in the above embodiments can be applied to various terminal devices (such as computer, mobilephone, personal digital assistant) to promote the read perfonnance of these terminal devices.

In particular, for example, it is provided that a computer device includes a file access system described according to the above embodiments of the invention, to promote the reading performance of the computer device. In addition, since the improvement of the invention does not relate to improvements of the structures and the functions of other components of the computer device, the descriptions of the structures and the functions of the commonly-known components in the computer device are omitted. By applying the file access system described according to the above embodiments of the invention to the computer device, the reading speed for files can be effectively promoted, and since the price of a storage card is relatively low, the production cost of the computer device is not be affected. In addition, since the files on the storage card such as SD card are the copies of the files on the HDD, even in the case that the storage card is plugged out or damaged, the system of the computer device is not affected, and in the case that it is not necessary to promote the reading speed of the computer (for example, in the case that the computer is turned off), the storage card can be further used as a storage of other devices (such as digital camera, digital camcorder, digital player and so on).

The above descriptions are only preferred embodiments of the invention, but not used to limit the invention. For the person skilled in the art, the invention may have various alternations and modifications. Any modification, equivalent alternation, improvement and so on made within the scope of the spirit and the principal of the invention should be included in the protection scope of the invention.

1. A stored data reading device, comprising:
a first storage module, configured for storing first data, the first storage module having a first reading speed;
a second storage module configured for storing second data, the second data being same with at least a part of the first data, the second storage module having a second reading speed, and the second reading speed is greater than the first reading speed;
a request acquiring module configured for acquiring a reading request for third data, the third data being the same with at least a part of the first data; and
a reading module for reading the third data from the second storage module when the second storage module includes the third data; and
reading the third data from the first storage module when the second storage module does not include the third data therein.

2. The device of claim 1, further comprising a determining module configured for determining whether the second storage module includes the third data based on a file list; and outputting the determination result to the reading module wherein, the file list stores information for describing the second data.

3. The device of claim 1, further comprising a filtering module configured for processing a first target address to obtain a second target address, the second target address pointing to the second storage module, wherein the first target address is included in the reading request for the third data, the first target address pointing to the first storage module.

4. The device of claim 3, wherein the reading module performs a reading operation to the second storage module to determine whether the second storage module includes the third data, based on the reading request that includes the second target address.

5. The device of claim 3, wherein the reading module performs a reading to the file list to determine whether the second storage module includes the third data and outputting the determination result to the reading module based on the reading request that includes the second target address, wherein the file list stores information for describing the second data.

6. The device of claim 1, wherein the second storage module stores the second data in a form of file.

7. The device of claim 1, wherein the second data is the data on which the reading requirement is greater than the modification requirement.

8. A stored data reading method, comprising:
acquiring a reading request for third data, the third data being the same with at least a part of first data, the first data being stored in a first storage module, the first storage module having a first reading speed; and
reading the third data from a second storage module when the second storage includes the third data;
wherein the second storage module is used to store second data, the second data being the same with at least a part of the first data, the second storage module including a second reading speed, the second reading speed being greater than the first reading speed.

9. The method of claim 8, wherein after the acquiring the reading request for the third data, further comprising determining whether the second storage module includes the third data; and outputting the determination result based on a file list, wherein the file list stores information for describing the second data.

10. The method of claim 9, wherein after the acquiring the reading request for the third data, further comprising processing a first target address to obtain a second target address, the second target address pointing to the second storage module, wherein the first target address is included in the reading request for the third data, the first target address pointing to the first storage module.

11. The method of claim 10, further comprising performing a reading operation to the second storage module to determine whether the second storage module has the third data, based on the reading request including the second target address.

12. The method of claim 10, further comprising performing a reading to the file list to determine whether the second storage module includes the third data; and outputting the determination result based on the reading request that includes the second target address, wherein the file list stores information for describing the second data.

13. A computer device, comprising:
a stored data reading device including:
a first storage module configured for storing first data, the first storage module having a first reading speed;
a second storage module configured for storing second data, the second data being the same with at least a part of the first data, the second storage module having a second reading speed, the second reading speed being greater than the first reading speed;
a request acquiring module configured for acquiring a reading request for third data, the third data being the same at least a part of the first data; and
a reading module configured for reading the third data from the second storage module when the second storage module has the third data, the reading module configured to read the third data from the first storage module when the second storage module does not have the third data.

14. The apparatus according to claim 1, wherein the first data, the second data and the third data comprise file data.

15. The stored data reading method according to claim 9, wherein, the first data, the second data and the third data are file data.
